(19) United States
(12) Patent Application Publication
(10) Pub. No.: US 2008/0226505 A1
(43) Pub. Date: Sep. 18, 2008

(54) Gas Sensor Assembly With Catalytic Element

(75) Inventors: Martin John Willettt, Hants (GB); David Frank Davies, Southampton (GB); Ali Hosseinmardi, Portsmouth (GB); Laurence Joyce, Bognor Regis (GB)

Correspondence Address: SCULLY SCOTT MURPHY & PRESSER, PC, 400 GARDEN CITY PLAZA, SUITE 300, GARDEN CITY, NY, 11530, US

(73) Assignee: CITY TECHNOLOGY LIMITED, Berkshire (UK)

(21) Appl. No.: 11/912,041

(22) PCT Filed: Apr. 18, 2006
(86) PCT No.: PCT/GB2006/001401

§ 371 Date: Jan. 16, 2008

(30) Foreign Application Priority Data
Apr. 19, 2005 (GB) 0507895.1

(51) Int. Cl. B01J 19/00; G01N 27/00

(52) U.S. Cl. 422/98; 422/83; 73/23.21

(57) ABSTRACT

A gas sensor assembly comprising a gas-sensitive element, and a first pulse modulation circuit comprising a first switching device is disclosed. The gas-sensitive element and the first switching device are arranged in series with a power supply. The first pulse modulation circuit further comprises a first control module adapted to control the first switching device in accordance with a monitored parameter of the gas-sensitive element, the parameter varying with the temperature of the element, thereby controlling the power consumed from the power supply by the gas-sensitive element.

This invention relates to gas sensor assemblies, in particular those employing a catalytic element to detect target gases in the surrounding atmosphere by monitoring a change in temperature caused by gas reacting on the surface of the element.

The use of calorimetric methods for the measurement of combustible gases which undergo exothermic oxidation reactions in a background of ambient air is well known. For instance examples are described in WO04/048955 and in “Calorimetric Chemical Sensors”, P. T Walsh & T. A Jones, Chapter 11 in “Sensors—A Comprehensive Survey” Vol. 2, Eds. W Gopel, J. Hesse & J. N. Zemel.

The most common type of such device is usually referred to as the catalytic sensor or pellistor and typically comprises a wire coil (usually platinum) surrounded by a refractory bead (alumina, zirconia or similar) impregnated or coated with a catalyst. This detector bead is typically between about 0.4 mm and 1.0 mm in diameter. The temperature of the structure is elevated to about 500 C by the passage of current through the coil, at which point the catalyst (normally a highly dispersed precious metal such as palladium) becomes highly active in promoting oxidation of the target gas species. The heat produced by the reaction is detected via its effect upon the electrical properties of the coil, which acts not only as a heater but also as a temperature sensor. Conveniently, the resistance of the coil is measured since this is proportional to its temperature and can thus be directly related to the target gas concentration.

Measurements from such a detector bead are certainly useful, but in order to provide accurate and reliable data under a range of conditions or over long periods of time, it may be necessary to compensate for other effects which may alter the temperature of the pellistor. For example, the ambient humidity, temperature and airflow can all influence the behaviour, whilst changes in the bead with time can give rise to drift. Although it is in principle possible to measure some of these parameters using other sensors and compensate accordingly, it has been found that the most effective means of compensation is to use a near-identical bead (the ‘compensator’) which is inert toward the target reaction but which otherwise responds in the same way as the gas-sensitive element (the ‘detector’). For this reason, pellistors are usually encountered as a pair of matched detector and compensator beads. The above-referenced article by Walsh and Jones is a good summary of the main options for pellistor operating circuits—constant voltage, constant current or constant temperature operation. Typically, bridge circuits are employed as a convenient way to monitor the difference between the detector and compensator outputs.

For reasons of cost and practicality, constant voltage or current bridges have historically been most widely employed in commercial instrumentation. However, for optimum bridge performance, “matched” (near-identical) detectors and compensators are required. ‘Matching’ is probably best defined in terms of matching the performance of the compensator in response to all conditions other than the presence of flammable gas to that of the detector.

There are a number of conventional approaches to achieve this. One can, for example, make identical coils and beads and then apply catalyst to one half and poison to the remainder. The beads are as near to being physically identical as one can manage, but may still need a trimming (shunt) resistor across one or other element in a bridge to achieve a perfect balance under standard conditions. Notwithstanding the close similarity of the elements, there is still no guarantee of perfectly matched compensation behaviour, however. Manufacturing tolerances, as well as the different bead colours and slightly different thermal conductivities resulting from the catalyst/poison divergence can introduce variances which result in imperfect balancing at standard conditions and/or a degradation of compensation behaviour at extremes of operating conditions. Further, the requirement for matched elements adds to the cost and difficulty in manufacturing a complete sensor. Were this requirement to be removed, whilst still retaining the performance of the sensor, significant cost savings could be achieved.

One of the main concerns in selecting a calorimetric gas sensor for an application is the power consumption of the device. Modern pellistor pairs typically consume about 200-300 mW, and some larger devices require twice this amount. Whilst this is generally not a major issue for fixed installations that are powered from a main electricity supply, the same cannot be said of the small portable gas monitors where a majority of such sensors find application. Indeed, the battery required to run a pellistor for a typical working shift of 8 hours will occupy well over half the volume of a typical multigas sensor employing electrochemical sensors for the detection of oxygen and toxic gases alongside a pellistor pair for flammable gas detection. Users and manufacturers of such equipment are therefore keen to identify pellistors offering significantly reduced power consumption so that smaller, lighter and cheaper instrumentation may be designed.

Many attempts have been made to reduce the power consumption of these sensors without unduly compromising the performance. For example, smaller beads have been fabricated on wires even thinner than the 10 micron diameter currently used in typical devices. However, the manufacturing processes required are difficult to control and yields are poor. Low power micromachined planar heaters have also been demonstrated, but significant problems remain in providing such structures with a catalyst coating offering the required activity and lifetime.

JP-A-6-160318 discloses a feedback system controlling the application of power to a heater through a switching device which is opened or closed depending on whether or not the resistance of the heater exceeds a predetermined threshold. However, this permits only coarse control of the heater resistance and hence temperature. Moreover, the system can only be operated in this mode for a fraction of the operating time, since measurements of the heater temperature can only be taken when the circuit is held in a steady-state condition and constant power is supplied to the heater. Hence, the power saving is not high.

WO03/102607 proposes the use of digitally controlled pulse width modulation to control power supply to the elements, which has been found to conserve some energy. However the sensor configurations disclosed in WO'607 do not make significant power savings, the main aim of the disclosure being to achieve dual mode operation where low gas concentrations are measured using the detector to measure the catalytic effect, while the compensator (only) is employed as a thermal conductivity sensor in the high concentration range.

Another approach is to switch off the elements for intermittent periods of time during operation. However the elements must be switched on for periods sufficient for them to reach their recommended operating temperature and for their performance to stabilise in order for the accuracy of their output to approach that which would be obtained in conventional continuously powered circuits.

One technique is to intermittently power a conventional constant voltage bridge employing matched detector-compensator elements. We have operated such pellistor pairs at a reading interval of 10 seconds. However, the elements undergo about 1.5 million on/off cycles in a typical operating life of 2 years, 5 days per week, 8 hours per day, as compared with about 2000 cycles if operated conventionally (assuming 4 on/off cycles per 8 hour shift). The current/voltage pulses were found to shorten bead lifetime and result in unacceptably high rates of drift in conventional elements. Larger elements offered some improvement but almost entirely negated the power savings achieved. ‘Soft start’ methods to limit the thermal shock experienced by the elements offered only limited benefits in extending lifetime and inevitably lengthened the overall cycle time to an undesirable degree. Indeed, intermittent operation of pellistor pairs with very low duty cycles (ie where the ‘off’ time is much longer then the ‘on’ period) may offer significant power savings, but the approach results in long intervals between detector readings which can allow dangerous accumulations of combustible gas to occur undetected.

A similar technique is disclosed in U.S. Pat. No. 5,780,715, in which the detector and compensator elements form part of separate, conventional feedback circuits, each of which can be switched on and off individually by a control circuit, primarily to allow different modes of operation at different gas concentrations. This arrangement suffers from all of the above problems, such that in practice, at least the detector element must be powered continuously and the associated power saving is small.

In accordance with a first aspect of the present invention, a gas sensor assembly comprises a gas-sensitive element, and a first pulse modulation circuit comprising a first switching device, the gas-sensitive element and the first switching device being arranged in series with a power supply, wherein the first pulse modulation circuit further comprises a first control module adapted to control the first switching device in accordance with a monitored parameter of the gas-sensitive element, the parameter varying with the temperature of the element, thereby controlling the power consumed from the power supply by the gas-sensitive element.

A pulse modulation circuit, by definition, produces a periodic series of pulses and modulates the width and/or frequency of the pulses to adjust the “duty cycle” of the control signal. For a series of rectangular pulses, the duty cycle is the ratio or percentage of the pulse duration (width) to the pulse period (1/frequency). The pulse modulation circuit may alternatively or in addition modulate the amplitude of the pulses. Here, the series of pulses controls the first switching device between open and closed states. In one example, when the control signal is “low”, the switching device is open and no power is supplied to the detector element. Conversely, when the signal is “high” the switching device is closed and power is supplied to the detector element through the switching device. Of course, the circuit could be arranged such that the switching device is open when the signal is “high”, and vice versa.

By controlling power to the gas-sensitive element through a pulse modulated switch in series with the element, the power consumption can be significantly reduced. The use of a pulse modulation circuit which can isolate the element from the power supply means that not only is the energy used in operation of the element reduced, but switching on and off of the element for intermittent periods (over a timeframe typically much longer than that of the pulse modulation circuit), if desired, can be effected by the same components, reducing energy consumption further. In the “off” periods, the current through the element, drawn from the power supply, is effectively reduced to zero.

Advantageously, the first pulse modulation circuit further comprises a first load resistor, the first switching device, gas-sensitive element and first load resistor being arranged in series with the power supply. The load resistor provides a convenient and accurate way to indirectly monitor the parameter of the element, by measuring the voltage drop across or current through the resistor and relating it to that of the element. The load resistor is designed to maintain a substantially constant resistance across the operational range of the device and so provides a measurement independent of changes in the environment.

In practice, this has been found to be a low cost, advantageous measurement technique. However, measurements could equivalently be carried out by an ammeter in series with the element and power supply, or by any alternative known methods of measuring current or voltage. Unlike conventional designs however, since in each case the series-connected switching devices switch current flow through both components between full power and zero (as opposed to a reduced level), they facilitate the imposition of an “off” or inactive period on the circuit which allows a substantial power saving to be made.

Preferably, the first pulse modulation circuit is a constant temperature circuit in which the first control module controls the first switching device so as to maintain the gas sensitive element at an approximately constant temperature. Such constant temperature operation is advantageous since the element remains at its designed operating condition and thus its performance is optimised. For example, avoiding detector catalyst temperature increase in the presence of high gas concentrations prevents damage and improves linearity in the output. However, a number of circuit design options are available and the detector element could be kept at constant voltage or current instead for example.

Advantageously, the first control module comprises a processor adapted to monitor a parameter of the gas sensitive element and to generate a first pulse modulated signal in accordance with the monitored parameter, the first pulse modulated signal being used to control the first switching device.

Such digital implementations are highly power-efficient because, unlike an analogue regulator circuit for example, a digital switch consumes only the energy needed to power the digital processor, which is typically small, in order to toggle between the two states (“high” and “low”). An analogue circuit, on the other hand, switching between a high voltage and a low voltage rail, not only has to dissipate energy from the high voltage rail when the circuit is in the “low” state, but also has an inherently large energy consumption owning to the large number of components in the circuit.

Moreover, the use of a processor in place of analogue components means that the device can be adapted for the particular application simply by means of different programming. Further, previous difficulties relating to the implementation of constant temperature circuits in analogue form are considerably eased by the introduction of micro-processors capable of performing most of the required functions. However, the first control module could comprise a circuit of analogue components capable of carrying out pulse modulation. For example, a switching device could be controlled by an appropriate configuration of error amplifiers of comparators which effectively produce a pulse modulated signal.

Preferably the gas sensor assembly further comprises a compensator element connected to the power supply independently of the gas-sensitive element.

The compensator element accounts for changes in the ambient environment which could otherwise distort the sensor output from the sensor. By controlling the compensator element independently of the gas sensitive element, it is possible to operate each element separately. For example, one element could be operated continuously, and the other intermittently in order to conserve power. This is made possible by providing each element with a separate control circuit. Control could be achieved by analogue or digital means.

Given that the two elements are disposed in separate circuits, there is no longer a requirement to match the elements to one another. The degree of design freedom becomes significantly greater when operating in a separate circuit regime. For example, in a conventional bridge circuit under constant voltage operation, if the detector requires higher voltage than the compensator, then this voltage difference must be dissipated wastefully within the circuit. Elements having significantly different properties cannot be operated effectively in bridge circuits due to the very large out of balance condition which would arise under normal operation. In separate circuits, the designer is freed from the need to achieve a near-zero output under standard conditions. Secondly, he is able to purposely choose and design the operating temperature of each element so that it achieves its required performance, be that good stable sensitivity (for the detector) or good compensation performance at high/low ambient temperature (for the compensator). For instance, it may be advantageous to make one of the elements more mechanically robust that the other, so that it can withstand more thermal cycling.

Conveniently, the compensator element forms part of a feedback circuit adapted to maintain a parameter of the compensator element which varies with temperature at an approximately constant value. Thus in one embodiment, the detector element may be controlled by pulse modulation whilst the compensator element is controlled by conventional techniques.

Advantageously, the gas sensor further comprises a second pulse modulation circuit comprising a second switching device, the compensator element and the second switching device being arranged in series with a power supply, wherein the second pulse modulation circuit further comprises a second control module adapted to control the second switching device in accordance with a monitored parameter of the compensator element, the parameter varying with the temperature of the element, thereby controlling the power consumed from the power supply by the compensator element. This enables full pulse modulated control of both elements individually, thus minimising power consumption.

Preferably, the second control module comprises a processor, which is further adapted to monitor the parameter of the compensator element and to generate a second pulse-modulated signal in accordance with the monitored parameter, the second pulse-modulated signal being used to control the second switching device. As discussed above with reference to the gas-sensitive element, such digital control offers great versatility.

Preferably, the second pulse modulation circuit is a constant-temperature circuit in which the second control module controls the second switching device so as to maintain the compensator element at an approximately constant temperature. It is particularly advantageous to operate both the gas-sensitive and compensator element in individual constant temperature circuits, since each element will remain at its optimum operating temperature. Alternatively, the second pulse modulation circuit could be a constant voltage or constant current circuit.

Conveniently, the monitored parameter of the gas sensitive or compensator elements could be any of the resistance of, voltage across or current through the respective element.

Preferably, the gas sensitive element is maintained at a temperature higher than that of the compensator element. This not only saves power, since less energy is expended in heating the compensator element, but also reduces the thermal stress on the compensator element should it be operated intermittently, thereby prolonging the lifetime of the element.

Preferably, the gas sensor further comprises a controller for controlling each of the first pulse modulation circuit and the feedback or second pulse modulation circuits independently of each other. This allows for a further level of control to be implemented on top of the basic control carried out by the first and second control modules (or feedback circuit). The controller can be used to set an operation cycle for each element, for example operating one or both of the elements for intermittent periods. Preferably, the controller controls each of the circuits independently of the gas sensitive and compensator elements. For example, the operation cycles could be preprogrammed according to the application or set by the user as desired.

Preferably, the controller generates first and second operation signals, each defining a “low” state and a “high” state, which control the first pulse modulation circuits and the feedback or second pulse modulation circuit respectively. For example, where both the gas sensitive element and compensator element are controlled by pulse modulated switches, the first and second operation signals are combined with the first and second pulse modulation signals respectively to control the first and second switching devices.

Preferably, the first operation signal is periodic with a repeating cycle time T₁ and the second operation signal is periodic with a repeating cycle time T₂. T₁ and T₂ may be different to one another, each element therefore operating at a different operational frequency.

Preferably, the first operation signal is continuously “high”, such that the first switching device is under the control of the first control module at all times. Such continuous operation of the detector element solves a number of problems. Firstly, the element is not subject to a large number of temperature cycles and so does not suffer from the shortened lifetime and high drift rate encountered using conventional techniques. Further, since the detector is active at all times, there is no risk of “missing” a sudden change in the target gas concentration. However, further power savings could be achieved by operating the detector element intermittently.

Preferably, the second operation signal is high for a predetermined proportion of the cycle time T₂ and low for the remaining proportion during which the second switching device is in an off state. By only operating the compensator for a fraction of each cycle, it is possible to save significant amounts of energy. Since changes to the ambient atmosphere typically take place over a much longer time period than, for example, sudden leaks of the target gas, it is relatively safe to operate the compensator intermittently. The compensation of the detector signal can be updated each time the compensator element is operational (the second operation signal is high). In between active periods, the compensator signal obtained during the proceeding operational period can be used. A memory component (which may form part of the processor) may be provided to store this signal.

In order to save power, it is preferable to operate the compensator element for only short periods of time. Advantageously, the proportion of time for which the second operation signal is high is less than T₂/2, preferably about T₂/12. In practice, the selected proportion should provide a good compromise between power saving and generating an accurate output. Factors to consider include:

what interval between compensator updates is acceptable to take account of changes in the ambient environment; and

how long the compensator element need be “active” in order to reach its optimum operating temperature and settle to produce an accurate reading.

Optimal power saving will be achieved by selecting the maximum acceptable interval (“off”/“inactive” period) between updates and the minimum acceptable “active” period.

Optionally, the controller may be further adapted to control each of the first pulse modulation circuits and feedback or second pulse modulation circuit in accordance with the monitored parameter of their respective elements. For example, if the temperature of the gas-sensitive element becomes dangerously high or if the concentration of target gas rises above a certain limit, such as the lower explosion limit, the detector may be switched off. Therefore preferably the controller is adapted to switch the first pulse modulation circuit off if the monitored parameter passes a predetermined threshold value.

Advantageously, at least the gas-sensitive element, the first switching device and the first control module are disposed within a sensor housing, the sensor housing being provided with at least one aperture for gas ingress. This results in a self-contained sensor and control unit which is convenient to use and readily integrated into existing systems. Any additional components such as the compensator element and load resistors may also be disposed inside the housing. Preferably, the housing is flameproof, in which case it may be provided with a flame arrester. However, for less safety-critical applications, the housing could be uncertified.

In accordance with a second aspect of the present invention, a method of operating a gas sensor assembly in accordance with the first aspect of the present invention is provided and comprises the steps of

(A) supplying power to the gas-sensitive element;

(B) monitoring a temperature-dependent parameter of the gas-sensitive element;

(C) generating a first pulse-modulated signal in accordance with the monitored parameter;

(D) controlling the power supplied to the gas-sensitive element by means of the first pulse-modulated signal such that the monitored parameter is maintained at an approximately constant value;

(E) generating a first output representative of the first pulse-modulated signal; and

(F) relating the output to a concentration of a target gas.

Where a compensator element is provided, the method preferably further comprises the steps of

(A′) supplying power to the compensator element;

(B′) monitoring a temperature-dependent parameter of the compensator element;

(C′) generating a second pulse-modulated signal in accordance with the monitored parameter;

(D′) controlling the power supplied to the compensator element by means of the second pulse-modulated signal such that the monitored parameter is maintained at an approximately constant value;

(E′) generating a second output representative of the second pulse-modulated signal;

(E′1) comparing the second output with the first output; and

(F′) relating a difference between the two outputs to a concentration of a target gas.

As previously described, it is preferable that steps (A) to (F) are performed continuously such that the detector elements remains on whilst steps (A′) to (F′) are performed for a predetermined proportion of a cyclic time period, the compensator element being off at all other times. In this way, a significant amount of power can be saved.

An example of a gas sensor assembly in accordance with the present invention will now be described with reference to the accompanying drawings, in which:

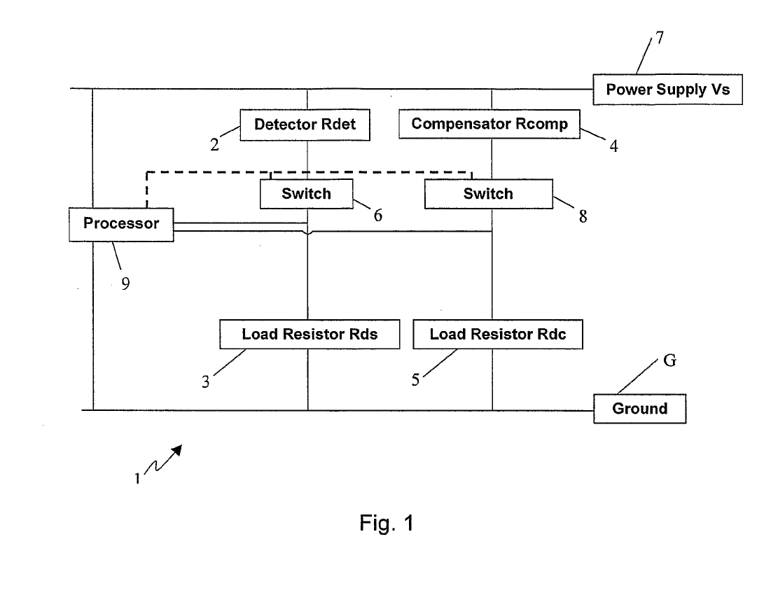

FIG. 1 is a schematic diagram illustrating the basic functional components of a first embodiment of the present invention;

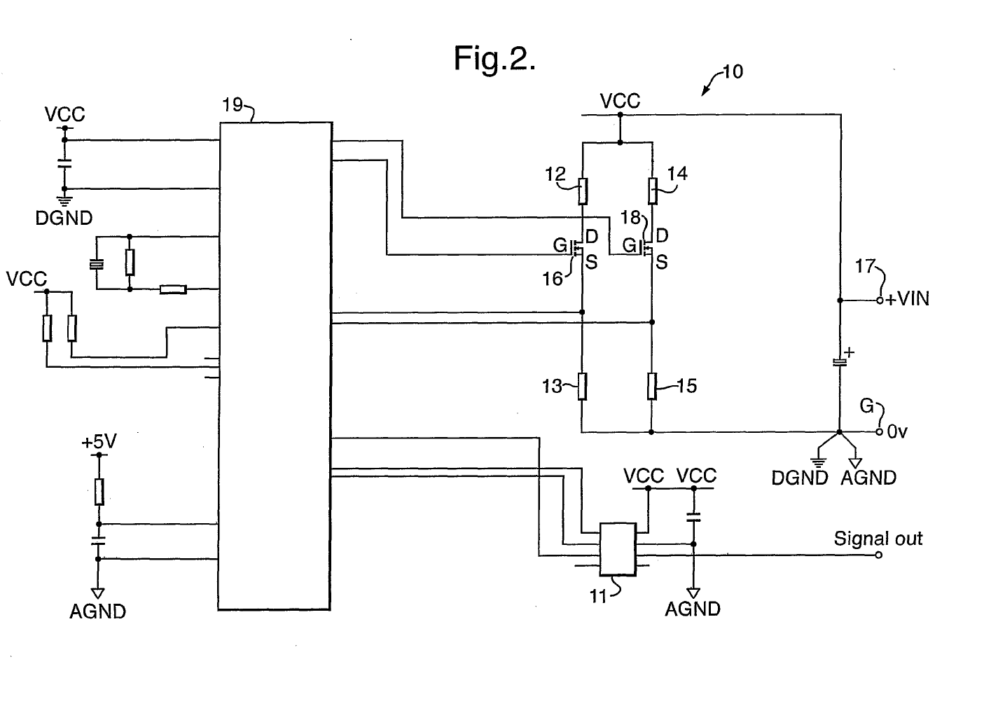

FIG. 2 is a circuit diagram depicting elements involved in the control of a gas sensor assembly according to a second embodiment of the present invention;

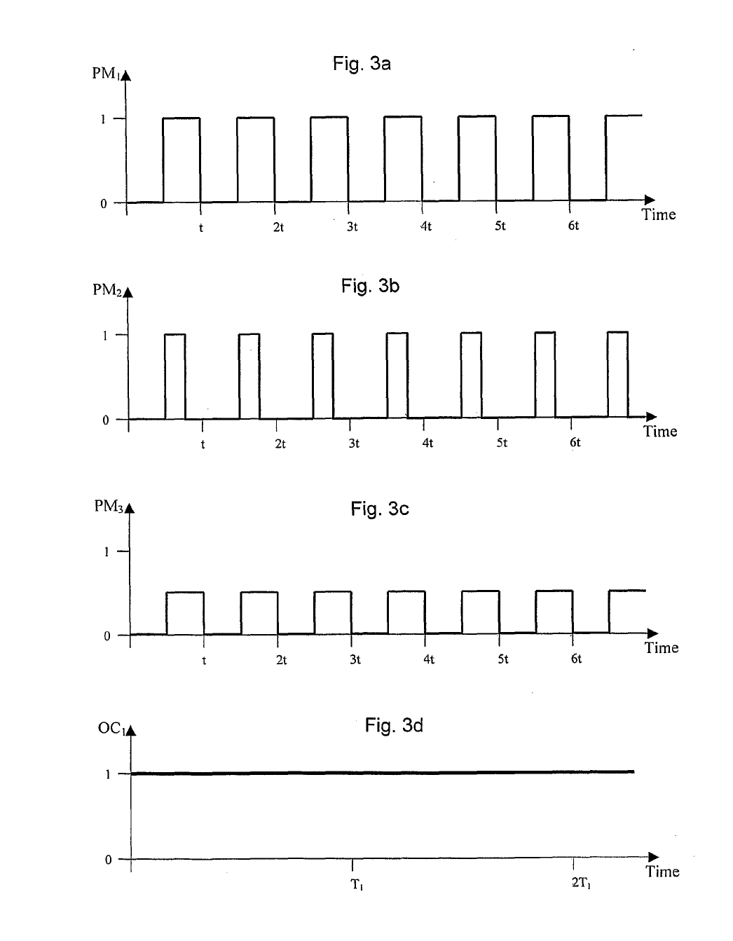

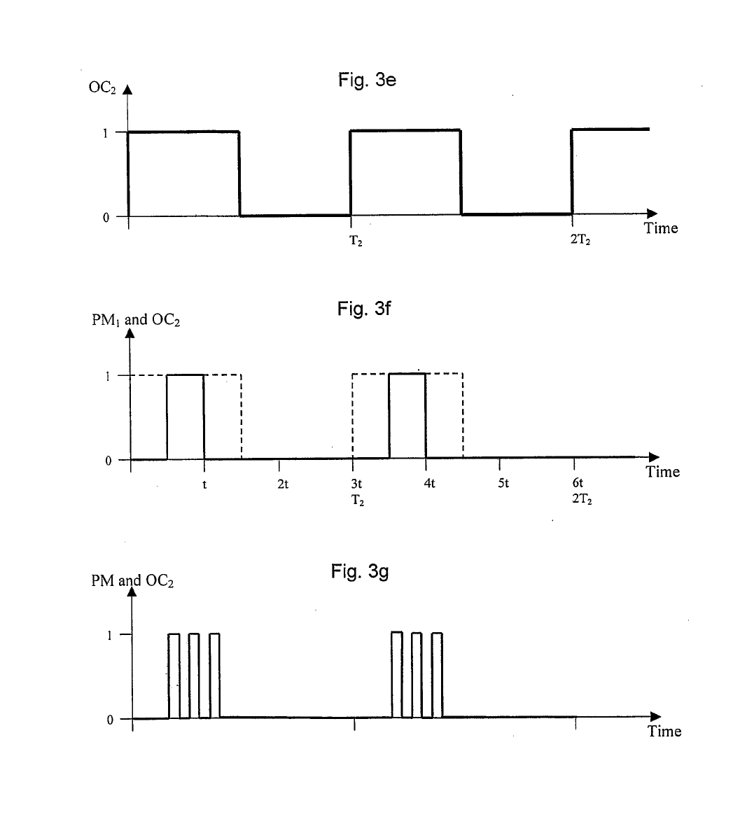

FIGS. 3a to 3g are graphs representing control signals;

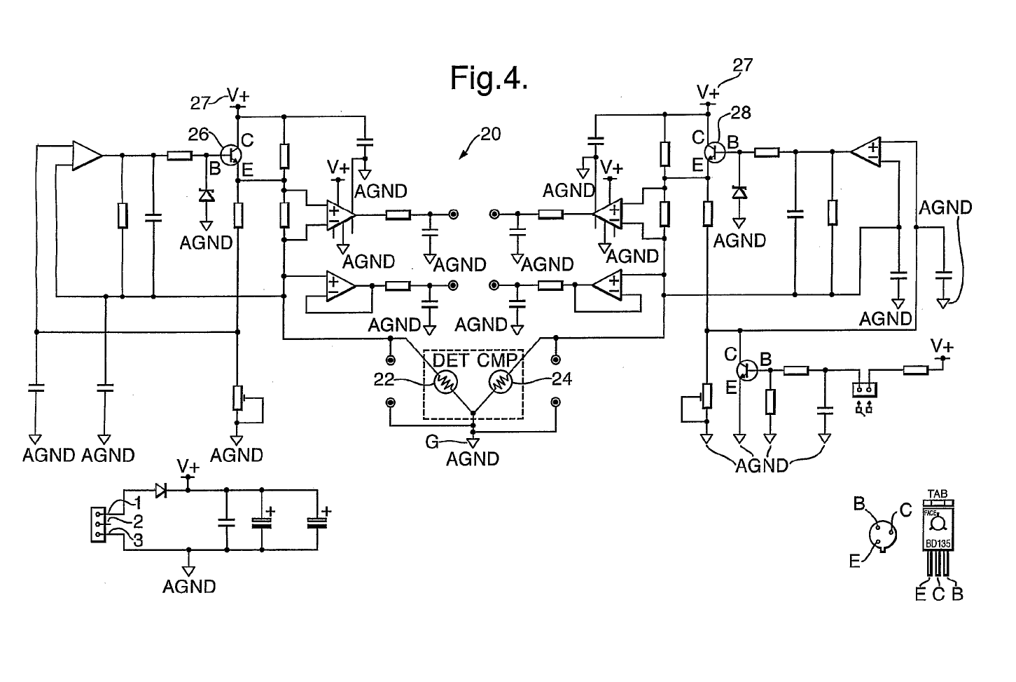

FIG. 4 is a circuit diagram illustrating components implementing a third embodiment of the present invention;

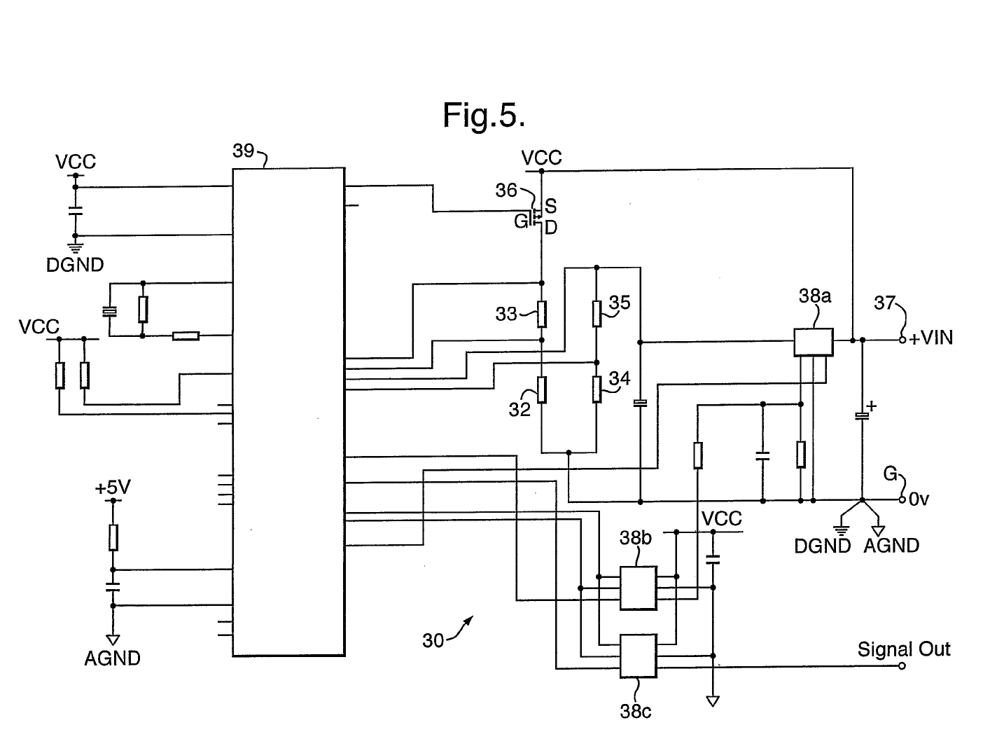

FIG. 5 is a circuit diagram illustrating a sensor assembly in accordance with a fourth embodiment of the present invention;

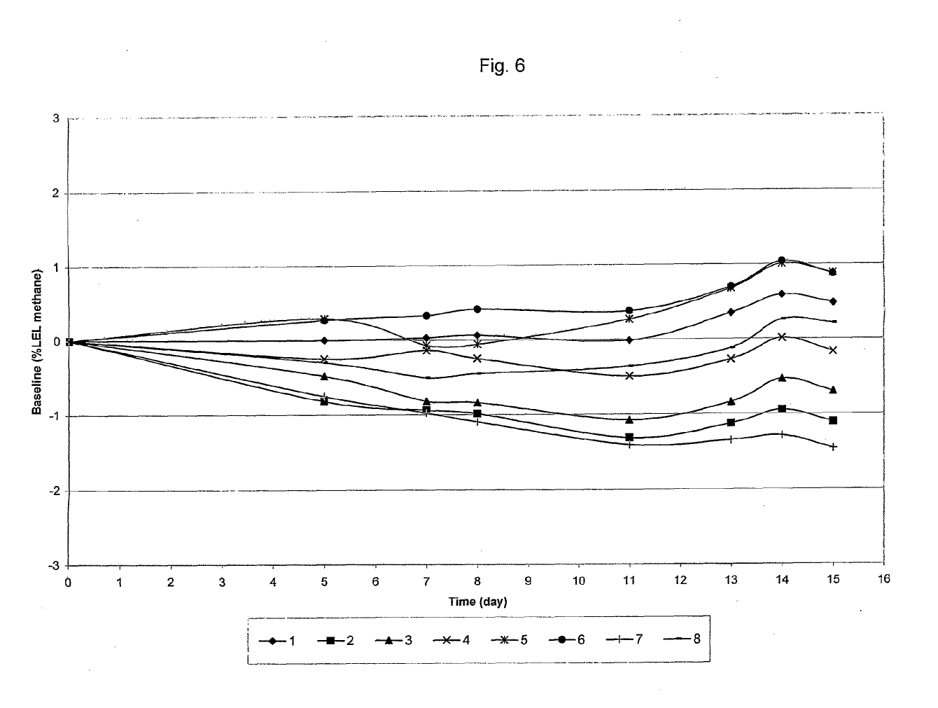

FIG. 6 is a graph showing the variation of base line with time for an example of a gas sensor assembly made in accordance with the present invention;

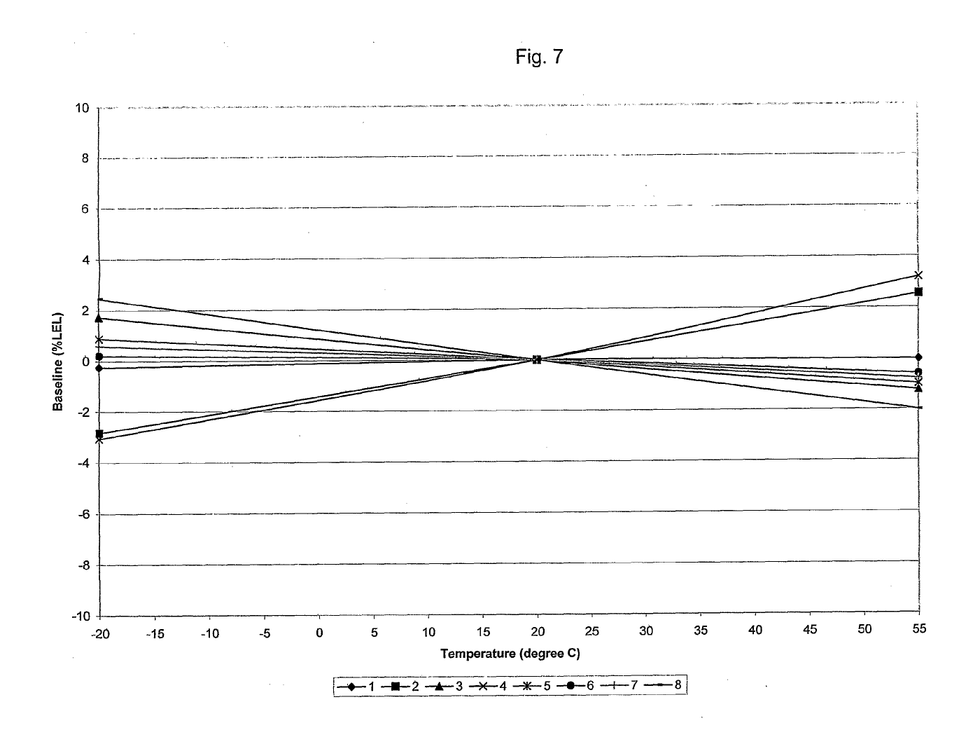

FIG. 7 is a graph depicting variation of base line with temperature in dry air for an example of a gas sensor assembly made in accordance with the present invention;

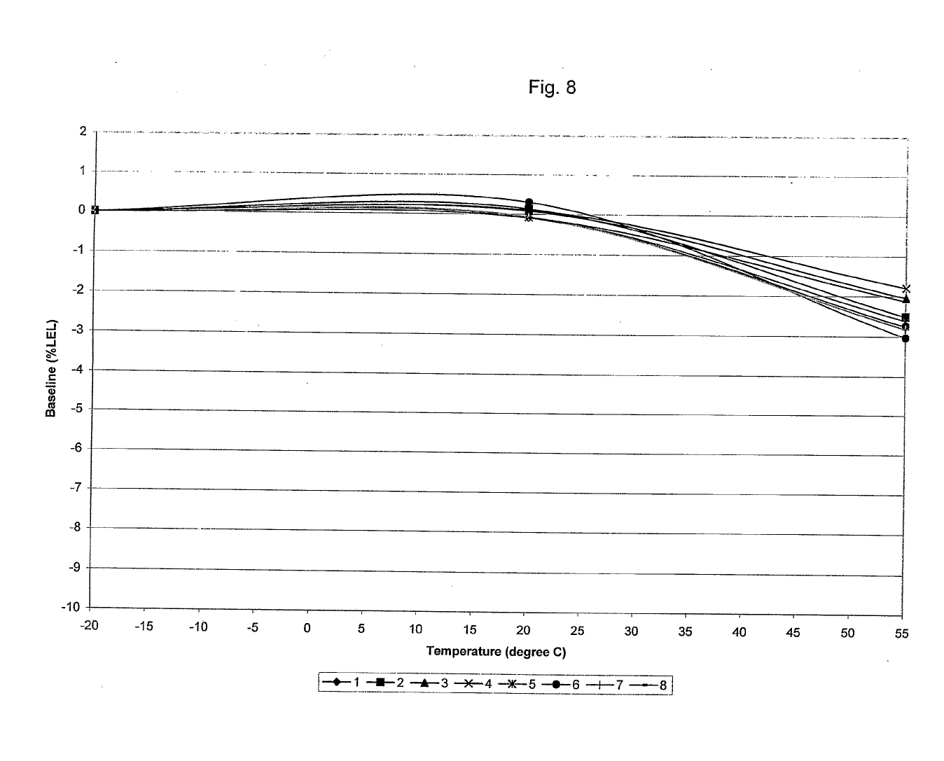

FIG. 8 is a graph showing the variation of the base line on changing between dry and water-saturated air at different temperatures for an example of a gas sensor assembly made in accordance with the present invention; and

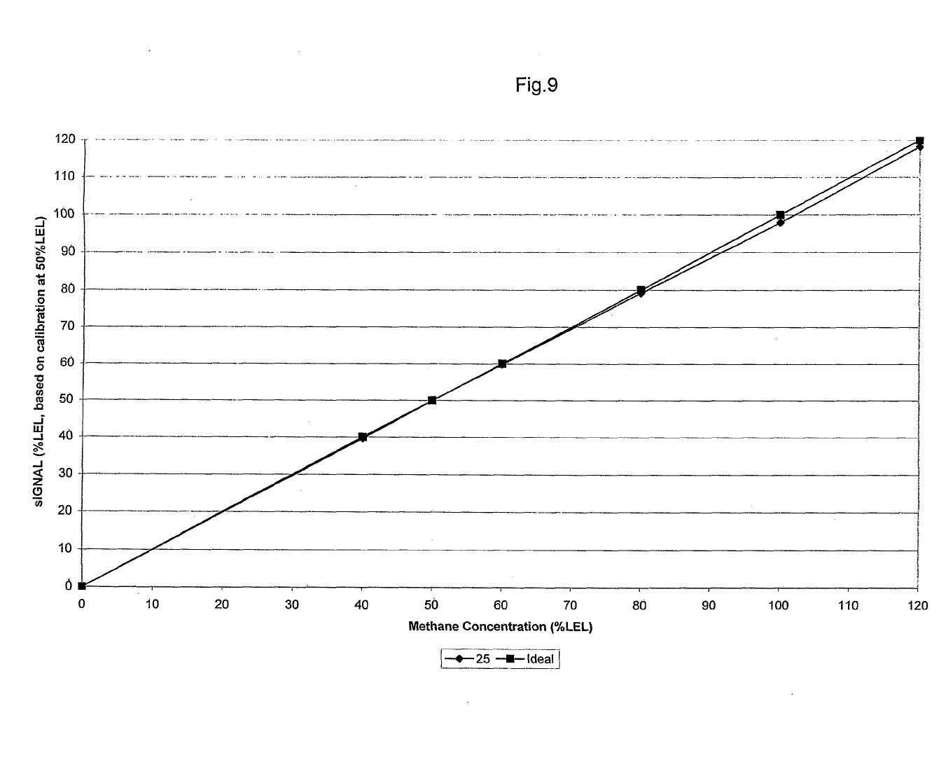

FIG. 9 is a graph showing the accuracy of the signal obtained from an example of a gas sensor assembly made in accordance with the present invention, shown as the signal obtained compared to the known gas concentration.

The basic concept is illustrated in FIG. 1 which shows a gas sensor assembly having a detector (gas-sensitive) element 2 of resistance R_{det} and a compensator element 4 having a resistance R_{comp}. The elements are typically enclosed in a sensor housing (not shown) which is provided with at least one aperture for gas ingress. The provision of a compensator element 4 is not essential but in practice beneficial, allowing changes in the ambient conditions to be taken into account when evaluating the sensor output. The two elements are disposed in parallel to one another meaning that they effectively perform part of separate circuits. Each of the elements is disposed in series with a switch 6, 8 which, in their “on” state, allow power to the respective elements 2, 4 from the power supply 7.

In this example, the switches 6 and 8 are controlled by processor 9. However, it should be noted that the compensator element 4 could be controlled by separate means, such as a feedback circuit. Further, the processor 9 could be replaced by analogue components capable of the same functionality. This will be described in later embodiments.

Load resistors 3 and 5 are also provided in each circuit. The processor 9 is connected to points between the sensor elements 2 and 4 and the load resistors 3 and 5. As such, the processor can monitor a parameter of each element, for example its resistance, the voltage across it or the current flowing through it. In practice, this measurement may be made across the corresponding load resistor 3 or 5, but since each branch of the circuit acts as a voltage divider, the measurement is analogous. For an accurate measurement to be taken, it is necessary to have a reliable measurement of the rail (power supply) voltage and, in some cases, an external reference voltage may be provided to achieve this.

The processor uses the measured parameters to generate control signals which operate switches 6 and 8. In this way, the power supply to each element can be adjusted according to the measured parameter. The series arrangement of switch 6 or 8, detector/compensator element 2 or 4 and load resistor 3 or 5 makes it possible to use the same physical configuration of components to operate the elements independently of one another in either constant current, constant voltage or constant temperature modes simply by selecting different software for control of the processor 9. The measurements input to the processor 9 allow the voltage across, the current through, or the temperature of the element to act as the control parameter such that the two elements 2 and 4 need not operate in the same mode. This can be particularly useful where the detector and compensator elements are of different types which, due to their construction, provide optimal performance under differing regimes, or where the user wishes to reconfigure instruments in the field to operate in a different mode.

For example, in constant temperature operation, the processor makes a measurement of the detector element's resistance (via current and voltage measurements). This is directly dependent on the temperature of the element which in turn is related to the concentration of target gas reacting on the element's surface. The processor 9 is programmed to output a pulse modulated control signal which keeps the resistance (temperature) of the detector element approximately constant. The frequency of the pulse modulated signal is fast compared to the thermal time constant of the element. As such, the pulsed nature of the control signal does not cause significant thermal cycling of the element and thus this aspect does not affect the longevity or drift characteristics of the element.

For example, suppose the power required to heat the detector element to is desired operating temperature is P. When there is no gas reacting on the element surface, all of this power P must be supplied by the power supply 7. However, if the target species is present in the atmosphere, it will combust on the element's surface evolving heat which will tend to increase the element's temperature and resistance. Thus in order to maintain a constant temperature, the amount of power supplied to the element must be reduced. In order to do so, on registering an increase in the detector resistance, the processor 9 reduces the power supplied to the detector from power supply 7 using switch 6. The compensator element may be maintained (in this example) at a constant temperature in much the same way. However, since the compensator element is inert to the target gas, it is changes in the ambient temperature which affect the compensator resistance, rather than gas concentration.

The processor 9 also generates a signal based on either the measured parameter of the detector element 2, the signal controlling switch 3 or a combination of both, which can be related to the concentration of target gas in the atmosphere and so provide a reading to the user. Typically, the output is based on a measure of the power supplied to the detector element 2, calculated from measurements of the current through the element, the voltage across the element and the duty cycle of the control signal. Where a compensator element 4 is provided, the output is based on a comparison between the signals from the two elements, carried out by the processor.

By providing each element 2, 4 with a switch 3, 5 which isolates the element from the power supply, it is possible to operate each element individually. Conveniently, each switch is subject to an operation cycle set by a controller which typically forms part of the processor 9. The frequencies of the operation cycles are generally slow compared to that of the pulse modulated signals. In a particularly preferred embodiment, the operational cycle applied to the detector is continuously on, meaning that the detector element is continually maintained in an “active” state, i.e. in this embodiment, maintained at (constant) operation temperature by the processor 9. Continuous operation of the detector is attractive in that it minimises thermal stress on the critical catalyst-containing element whilst providing continuous warning of gas leaks. The compensator element on the other hand is advantageously subject to an intermittent operation cycle, receiving power (controlled by the processor) during only a proportion of each cycle, and being switched off for the rest. The compensation signal obtained during each “active” period can be stored and used for comparison with the detector output during the “off” period. This may be carried out by the processor 9, or in analogue implementations, additional means may be provided for this purpose such as a sample or hold circuit, a memory component or any other known technique.

Operation of the elements in this way has the benefit that a significant amount of power can be saved compared to continuous running of the compensator element without compromising the accuracy and safety of the device. Further, by making the operation cycle (interval between active periods) relatively long, the number of temperature cycles can be kept to a minimum and thus thermal stress on the compensator element is reduced. Relatively low duty cycle intermittent operation of the compensator is generally quite adequate since ambient changes requiring compensation invariably occur over longer time scales than safety-critical gas escapes.

Further, this form of circuit does not require the gas sensitive (detector) and compensator elements to be matched. The design of each element can therefore be optimised for the quite different operating regime under which it will run. In particular, it is possible to employ a more robust construction for elements which will undergo frequent thermal cycling, for example by using different bead material or thicker wire. This allows more robust compensators to be used, limiting lifetime and drift concerns but also having minimal impact on the overall power consumption when operating at a low duty cycle (in practice, beads built using thicker wire generally require more power to heat to the same temperature).

Optionally, the operation cycles could be adapted so as to take account of changes in the parameters measured by the processor 9. For example, rapid changes in output of a continuously operated detector could trigger the system to produce updated compensator readings in a “normally off” period if required. Further, the controller could be designed to switch off the detector element circuit if its temperature becomes dangerously high or if the measured concentration of gas passes a predetermined threshold level, for example the lower explosion limit (LEL).

Depending on the means selected to carry out the above-described functions, it is envisaged that the control circuitry could either be arranged inside the sensor housing or externally. By appropriate selection of components the entire assembly can be integrated into a sensor housing, resulting in a convenient unit which may readily be incorporated into existing sensing devices. In order to do so, the physical size of the components must be suitable to fit within a housing and the part count should be as low as possible. Further, certain applications may require the completed sensor to be certifiably flameproof, and this may also need to be taken into account when selecting the control means. In this case, the sensor housing may be provided with a flame arrester in the form of a mesh or sinter disk which enables gas ingress but prevents explosive events.

Thus the gas sensor assembly exemplified in FIG. 1 provides an advantageous combination of

Continuous, accurate and frequently compensated gas concentration measurements

Power savings approaching 50% when compared with traditional operating methods

Performance at least equal and in some respects superior to that of conventional devices.

It will be appreciated that the concepts embodied in the example shown in FIG. 1 can be implemented in numerous ways, some of which will now be described.

FIG. 2 shows a preferred digital implementation of the circuitry shown in FIG. 1. In this example, both the detector element 12 and the compensator element 14 are controlled by processor 19 via respective switches 16 and 18. The control signals output from processor 19 to control each of the switches 16 and 18 are pulse modulated. This is shown schematically in FIGS. 3a to c which show an exemplary pulse modulated signal supplied to switch 16, designated PM₁. The signal shown has a 50% duty cycle and a frequency of 1/t. The width and frequency of the pulses determine the duty cycle and so the amount of power which is supplied to the detector element. By varying the duty cycle and/or amplitude, the power supplied to the element may therefore be adjusted. For example, if on monitoring a parameter of the element the processor identifies an increase in the element's temperature, the power supply to the element is reduced. This could be achieved by decreasing the duty cycle as shown in FIG. 3b which depicts a 25% duty cycle (PM₂). Alternatively, the amplitude of the pulses could be reduced as shown in FIG. 3c (PM₃).

The same technique can be used to control the compensator element.

The processor 19 provides a further level of control in the form of operation cycles which may be individually determined for each element 12,14. The operation cycles may be set in the factory or chosen by the user to suit a particular application. The operation cycle determines for how long each element is “active” i.e. being supplied with power controlled by the processor as described above. For the remainder of the time, the element is switched off, i.e. entirely isolated from the power supply.

In a preferred example, the detector element is subject to a first operation cycle, OC₁, which has a cyclic period T₁ throughout which the operation signal is “high” (FIG. 3d). This means that the detector is continually in its active state. In order to conserve power, as described above with reference to FIG. 1, the compensator element 14 is operated intermittently. Its operation cycle, OC₂, is only high for a portion of its period T₂. An example of OC₂ is shown in FIG. 3e, wherein the compensator element is active for the first half of each operation cycle. The control signal output by processor 19 to switch 18 is a combination of the pulse modulation signal PM₂ and the operation cycle OC₂ as shown in FIG. 3f. In reality, the frequency of pulse modulation is typically much greater than that of the operation cycle and as a result many pulses will take place in each active period (see for example FIG. 3g).

Notably, the pulse modulated switches 16, 18 are in series with the elements 12, 14 and their respective load resistors 13, 15. The current through the elements 12, 14 is therefore modulated between zero and full power, and each element may be separately isolated from the supply, either as demanded by the constant temperature pulse modulation scheme (PM) or during the longer off period of the intermittent operation cycle (OC). In this approach, resistance measurements of the elements are made while current is flowing. The supply voltage and the voltage at the junctions between the compensator 14 and detector 12 and their respective load resistors 15, 13 form inputs to the processor 19. This allows the calculation of the voltage drop-across each of these four elements and in combination with a knowledge of the load resistor values, the current flowing through each element 12, 14 may be determined and hence its resistance. The feedback loop operates in conjunction with the switches to maintain this resistance value (and hence the element resistances) at the required values.

The selection of the load resistor values is obviously important in minimising the unwanted power dissipation in these elements. However, the values must be large enough to provide a measurable signal at the processor input, and hence provide resolution capable of the required degree of temperature stability. A number of trade-offs are possible for the designer employing this approach. For example, lower resistor values may be used with (more expensive) processors having higher resolution and/or more sensitive A/D input lines. Alternatively, operational amplifiers may be incorporated to boost the voltage inputs to the processor.

It will be apparent that the generic arrangement shown in FIG. 2 could be modified to employ pulse amplitude modulation (FIG. 3c) in addition to, or instead of, the pulse width control described here. However, the approach shown is considered to offer a preferred compromise in terms of simplicity, cost and low power consumption.

Provided any variation in rail voltage is within acceptable limits, a further simplification and improvement which may be introduced is to use a processor in which the input voltage measurements are all internally referenced to the rail voltage. This eliminates the requirement for any additional external reference voltage generation, or a balance arm, thereby saving power, parts and cost. If the variation in rail voltage is not acceptable, it may be necessary to add an external reference voltage.

The generic operation of the design shown in FIG. 2 may be further explained by reference to the following equations

R_{det}=Resistance of Detector (gas-sensitive) element 12

R_{comp}=Resistance of Compensator element 14

V_{d}=Voltage across Detector element

I_{d}=Detector element current

I_{c}=Compensator element current

Vₛ=Supply Voltage

V_{rds}=Voltage across the Detector sense (load) resistor 13 (resistance R_{ds})

P_{det}=Power in Detector element

P_{comp}=Power in Compensator element

DC_{d}=Duty Cycle of PWM driving detector element

DC_{c}=Duty Cycle of PWM driving compensator element

Using typical values for the detector resistance (21.25 ohms), compensator resistance (18.57 ohms), supply voltage (3.3V) and series load resistors (3.3 ohms) we obtain

R_{det}=V_{d}/I_{d}=(Vₛ−V_{rds})/V_{rds}/R_{ds}=(Vₛ/V_{rds}−1)*R_{ds}

V_{rds}=Vₛ*(R_{det}/R_{ds}+1)⁻¹=Vₛ*(21.5/3.3+1)⁻¹=Vₛ*0.1344

Thus the set point to keep the Detector at a constant temperature=ADC count value*0.1344. The pulse width modulator drive is therefore adjusted to maintain this value constant. Using the same method we get a set point for the compensator=ADC count value*0.1509.

In a constant temperature circuit, the measurand is the power required to maintain the element at the chosen resistance and hence temperature. In this case, therefore,

P_{det}=(I_{d}*DC_{d})²*21.25 and P_{comp}=(I_{c}*D_{c})²*18.57.

Assuming a predetermined sensitivity calibration factor s (% LEL per mW), the final system output is a gas measurement in % LEL given by

(P_{det}−P_{comp})*s

In the embodiment depicted in FIG. 2, an integrated circuit 11 and associated circuitry are provided to supply a simple analogue output from the processor 19. This allows the circuit 10 to be readily incorporated into host instruments (sensor devices) which are traditionally used with conventional sensor circuits, such as Wheatstone bridge arrangements. However, where the host instrument is capable of receiving a digital output directly from processor 19, integrated circuit 11 and its associated circuitry can be removed.

It is clear that constant temperature operation requires that only a single variable element be included in each control loop—otherwise the multiple variables cannot be separated. This means that the sefies load resistors should be selected to have fixed resistances under the anticipated operating conditions.

Digital pulse modulation is the preferred method for minimising power consumption in these systems since it offers an improved and simplified implementation, more flexibility and has a lower parts count and hence reduces cost. Further, as a result of its low parts count, this embodiment is particularly well adapted for integration within a sensor housing. Provided a suitably small processor is selected, the control circuitry may conveniently be disposed inside the housing, which may further be flameproof. However, as inferred above, this is by no means the only technique by which the invention may be implemented. FIG. 4 shows a third embodiment comprising an analogue circuit in which the power supplied to the detector element 22 and the compensator element 24 is dictated by switching devices 26 and 28 respectively. Both elements can be maintained at a constant temperature and different operation cycles applied to each, This approach has some advantages, for example in that the need for programming digital processors is avoided, which can be time consuming. However, it has been found that the FET switches and other components consume significant amounts of power and so reduce the overall power saving. Further, the component count and therefore the cost of such an implementation is high.

A fourth embodiment is depicted in FIG. 5. This is a hybrid design which employs pulse modulated control of the detector element 32, but conventional feedback control of compensator element 34. Pulse modulated control is implemented by processor 39 of a switch 36 which is arranged in series with power supply 37, load resistor 33 and the detector element 32. The detector element 32 is operated as described above with respect to the first embodiment.

The compensator element 34 is controlled by means of a series regulator 38a which receives its control signal via a digital to analogue converter 38b. This in turn is fed by the processor 39 with the required correction signal calculated from the measurement of the compensator voltage and hence the compensator resistance. The power consumed by the compensator element can be calculated by processor 39. A digital to analogue convertor 38c may also be provided which produces an analogue output if required.

Whilst this embodiment is more complex then the fully digital version described in the first and second embodiments, it serves to illustrate the versatility of the concept.

### EXAMPLE

A MICROpeL® pellistor sensor manufactured by City Technology Ltd was modified by incorporating a more robust compensator design capable of operating at a lower power level (˜90 mW) than the compensators and detectors used in the standard device (˜130 mW each). The resistances of the detector and compensator at their normal operating points were as used in the example given above with respect to the second embodiment (which would normally render them inappropriate for operation in a conventional bridge circuit). Under standard atmospheric conditions, these sensors operate at a power level approximately equivalent to that which would be drawn were they to be continuously supplied from 1.70V and 1.30V rails for the detector and compensator respectively.

The chosen operating regime in this example involved having the compensator switched on (“active”) for 10 seconds in every 2 minutes. The total pellistor consumption was about 144 mW as opposed to about 257 mW in a conventional constant voltage 3.3V bridge, a saving of approximately 44%. FIG. 6 shows the baseline stability of such sensors over the first 15 days of operation, which compares favourably to the performance of conventional MICROpeLs in a constant voltage bridge. The steady-state baseline variation with ambient temperature (FIG. 7) and humidity (FIG. 8) is also comparable with that of conventionally operated sensors which consume almost twice the amount of power. The linearity toward methane (FIG. 9) is significantly improved, and response and recovery times of less than 3 s to 90% of the step change reading were obtained.

The data clearly shows that the proposed operating method offers comparable or improved performance with the major benefit of a substantial power saving. Further reductions in power could be envisaged by extending the compensator period between updates, and/or reducing the on time, although the accuracy of the overall system would eventually be compromised by taking such changes to the extreme.

Thus, by implementing such a constant temperature operating regime, preferably with a power-efficient digital control method as described earlier, and optionally utilising modified bead designs, equivalent or improved performance of pellistor pairs may be achieved with substantial power savings over existing methods.

1. A gas sensor assembly comprising a gas-sensitive element, and a first pulse modulation circuit comprising a first switching device, the gas-sensitive element and the first switching device being arranged in series with a power supply, wherein the first pulse modulation circuit further comprises a first control module adapted to control the first switching device in accordance with a monitored parameter of the gas-sensitive element, the parameter varying with the temperature of the element, thereby controlling the power consumed from the power supply by the gas-sensitive element.

2. A gas sensor assembly according to claim 1 wherein the first pulse modulation circuit further comprises a first load resistor, the first switching device, gas-sensitive element and first load resistor being arranged in series with the power supply.

3. A gas sensor assembly according to claim 1 or claim 2 wherein the first pulse modulation circuit is a constant-temperature circuit in which the first control module controls the first switching device so as to maintain the gas-sensitive element at an approximately constant temperature.

4. A gas sensor assembly according to claim 1 or claim 2 wherein the first pulse modulation circuit is a constant-voltage or constant-current circuit in which the first control module controls the first switching device so as to maintain the voltage across or current through the gas-sensitive element at an approximately constant-value.

5. A gas sensor assembly according to any of the preceding claims wherein the first control module comprises a processor adapted to monitor the parameter of the gas-sensitive element and to generate a first pulse-modulated signal in accordance with the monitored parameter, the first pulse-modulated signal being used to control the first switching device.

6. A gas sensor assembly according to any of the preceding claims wherein the monitored parameter is any of the resistance of, voltage across or current through the element.

7. A gas sensor assembly according to any of the preceding claims, further comprising a compensator element connected to the power supply independently of the gas-sensitive element.

8. A gas sensor assembly according to claim 7, wherein the compensator element forms part of a feedback circuit adapted to maintain a parameter of the compensator element which varies with temperature at an approximately constant value.

9. A gas sensor assembly according to claim 7, further comprising a second pulse modulation circuit comprising a second switching device, the compensator element and the second switching device being arranged in series with a power supply, wherein the second pulse modulation circuit further comprises a second control module adapted to control the second switching device in accordance with a monitored parameter of the compensator element, the parameter varying with the temperature of the element, thereby controlling the power consumed from the power supply by the compensator element.

10. A gas sensor assembly according to claim 9 wherein the second pulse modulation circuit further comprises a second load resistor, the second switching device, compensator element and second load resistor being arranged in series with the power supply.

11. A gas sensor assembly according to claim 9 or claim 10 wherein the second control module comprises a processor, which is further adapted to monitor the parameter of the compensator element and to generate a second pulse-modulated signal in accordance with the monitored parameter, the second pulse-modulated signal being used to control the second switching device.

12. A gas sensor assembly according to any of claims 9 to 11 wherein the second pulse modulation circuit is a constant-temperature circuit in which the second control module controls the second switching device so as to maintain the compensator element at an approximately constant temperature.

13. A gas sensor assembly according to any of claims 9 to 11 wherein the second pulse modulation circuit is a constant-voltage or control-current circuit in which the second control module controls the second switching device so as to maintain the compensator element at an approximately constant voltage or current.

14. A gas sensor assembly according to any of claims 9 to 13, wherein the monitored parameter is any of the resistance of, voltage across or current through the compensator element.

15. A gas sensor assembly according to claim 12 when dependent on claim 3 wherein the gas-sensitive element is maintained at a temperature higher than that of the compensator element.

16. A gas sensor assembly according to any of claims 7 to 9 further comprising a controller for controlling each of the first pulse modulation circuit and the feedback or second pulse modulation circuit independently of each other.

17. A gas sensor assembly according to claim 16 wherein the controller is further adapted to control each of the first pulse modulation circuit and the feedback or second pulse modulation circuit independently of the gas-sensitive and compensator elements.

18. A gas sensor assembly according to claim 16 or claim 17 wherein the controller generates first and second operation signals each defining a “low” state and a “high” state, which control the first pulse modulation circuit and the feedback or second pulse modulation circuit respectively.

19. A gas sensor assembly according to claim 18 wherein the first operation signal is periodic with a repeating cycle time T₁, and the second operation signal is periodic with a repeating cycle time T₂.

20. A gas sensor assembly according to claim 18 or claim 19 wherein the first operation signal is continuously “high”, such that the first switching device is under the control of the first control module at all times.

21. A gas sensor assembly according to claim 19 or claim 20 wherein the second operation signal is “high” for a predetermined proportion of the cycle time T₂, and “low” for the remaining proportion, during which the second switching device is in an off state.

22. A gas sensor assembly according to claim 21 wherein the proportion of time for which the second operation signal is “high” is less than T₂/2, preferably about T₂/12.

23. A gas sensor assembly according to any of claims 16 and 18 to 22 wherein the controller is further adapted to control each of the first pulse modulation circuit and feedback or second pulse modulation circuit in accordance with the monitored parameter of their respective element.

24. A gas sensor assembly according to claim 23 wherein the controller is adapted to switch the first pulse modulation circuit off if the monitored parameter passes a predetermined threshold value.

25. A gas sensor assembly according to any of the preceding claims wherein at least the gas-sensitive element, the first switching device and the first control module are disposed inside a sensor housing, the sensor housing being provided with at least one aperture for gas ingress.

26. A gas sensor assembly according to claim 25 wherein the sensor housing is flameproof.

27. A gas sensor assembly according to claim 26 wherein the sensor housing is further provided with a flame arrester.

28. A method of operating a gas sensor assembly according to any of claims 1 to 27 comprising the steps of:
(A) supplying power to the gas-sensitive element;
(B) monitoring a temperature-dependent parameter of the gas-sensitive element;
(C) generating a first pulse-modulated signal in accordance with the monitored parameter;
(D) controlling the power supplied to the gas-sensitive element by means of the first pulse-modulated signal such that the monitored parameter is maintained at an approximately constant value;
(E) generating a first output representative of the first pulse-modulated signal; and
(F) relating the output to a concentration of a target gas.

29. A method of operating a gas sensor assembly according to claim 28 when dependent on at least claim 9 further comprising the steps of:
(A′) supplying power to the compensator element;
(B′) monitoring a temperature-dependent parameter of the compensator element;
(C′) generating a second pulse-modulated signal in accordance with the monitored parameter;
(D′) controlling the power supplied to the compensator element by means of the second pulse-modulated signal such that the monitored parameter is maintained at an approximately constant value;
(E′) generating a second output representative of the second pulse-modulated signal;
(E′1) comparing the second output with the first output; and
(F′) relating a difference between the two outputs to a concentration of a target gas.

30. A method of operating a gas sensor assembly according to claim 28 or claim 29 wherein steps A to F are performed continuously.

31. A method of operating a gas sensor assembly according to claim 29 or claim 30 wherein steps A′ to F′ are performed for a predetermined proportion of a cyclic time period, T₂, the compensator element being off at all other times.

32. A method of operating a gas sensor assembly according to claim 31 wherein the proportion of time for which steps A′ to F′ are performed is less than T₂/2, preferably about T₂/12.

33. A method of operating a gas sensor assembly according to any of claims 28 to 32 wherein the temperature-dependent parameter is any of the resistance of, the voltage across or the current through the respective element.

34. A method of operating a gas sensor assembly according to any of claims 28 to 33, wherein steps A to D maintain the gas-sensitive element at an approximately constant temperature.

35. A method of operating a gas sensor assembly according to any of claims 29 to 34, wherein steps A′ to D′ maintain the compensator element at an approximately constant temperature.
